(19) United States
(12) Patent Application Publication
(10) Pub. No.: US 2006/0072140 A1
(43) Pub. Date: Apr. 6, 2006

(54) System and method for configuring printer driver settings

(75) Inventor: Masateru Mitani, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/957,696

(22) Filed: Oct. 5, 2004

(51) Int. Cl. G06F 15/00

(52) U.S. Cl. 358/1.13

(57) ABSTRACT

An apparatus and method for configuring printer driver settings of printer drivers stored on a computer. The printer drivers enable communication between the computer and a hardcopy device capable of printing. The method involves changing a setting of a first printer driver stored on the computer in response to a user request, detecting whether a second printer driver stored on the computer is identified in connection with a same port as the first printer driver, and changing at least one setting of the second printer driver to match the changed setting of the first printer driver if the second printer driver is identified in connection with the same port as the first printer driver.

### FIELD OF THE INVENTION

The present invention relates generally to printers and hardcopy devices and, more particularly, to a system and method for configuring printer driver settings used with printers and other hardcopy devices.

### BACKGROUND OF THE INVENTION

Hardcopy devices, such as printers or multi-function peripherals (MFPs), are capable of printing documents or images in response to a request from a user, typically in the form of a print job. The user can make the request (e.g., print job) from a personal computer (PC) or other type of computing or telephonic-based device. The request can be made through a network or through a local connection between the PC and the hardcopy device. The document or image to be printed may be located on the PC, at a centralized storage, such as a file server, or at a storage location in the hardcopy device, such as a box in an MFP.

To enable the PC or other computing device to communicate properly with the hardcopy device requested to make the print, the PC is typically loaded with one or more printer drivers. In general, a printer driver is an interface, e.g., a software interface, used by computer programs to communicate with printers and plotters. Printer drivers translate the information sent from the PC into commands that the hardcopy device understands. Usually, printer drivers are not compatible across platforms, so various drivers are installed to support different hardware and operating systems. For example, if one computing device is running a first operating system, and the hardcopy device is shared by another computing device running a different operating system, it may be necessary to install multiple printer drivers.

In general, printer drivers are made up of three types of files. A configuration or printer file displays the properties and preferences dialog boxes when you configure a printer. A data file provides information about the capabilities of a specific printer including, for example, its resolution capability, whether it can print on both sides of the page, and what size paper it can accept. Finally, a printer graphics driver file translates device driver interface (DDI) commands into commands that a printer can understand. Each driver translates a different printer language. For example, the file Pscript.dll translates the postscript printer language. When installing a new printer, the configuration file reads the data file and displays the available printer options. When printing, the graphics driver file queries the configuration file about the selections so that it can create the proper printer commands.

Each PC or computing device may be loaded with more than one printer driver for a given hardcopy device. For example, the PC may be loaded with a postscript (PS) printer driver and a printer control language (PCL) printer driver. The PS and PCL printer drivers are both types of printer drivers that use page description language (PDL).

Further, each printer driver on the PC has a plurality of settings configured to enable the PC to provide print jobs to the hardcopy device. These settings include, for example, the type of feeder, the type of finisher, use of a hole punch, paper size for each drawer, paper type, memory size, and any other setting that may be used to configure a printer driver. It is also possible to change the settings, such as changing the paper size in a particular drawer from letter size to A4 size. If more than one printer driver is assigned to the same port of the PC, then it is necessary for the user to manually change the settings of each printer driver individually. Furthermore, when installing a new printer driver, it is also necessary to configure the settings of the new printer driver manually in accordance with the settings of any existing printer driver that uses the same port.

### SUMMARY OF THE INVENTION

According to an aspect of the invention, an image forming apparatus and method for configuring printer driver settings of printer drivers stored on a computer. The printer drivers enable communication between the computer and a hardcopy device capable of printing. This aspect involves changing a setting of a first printer driver stored on the computer in response to a user request, detecting whether a second printer driver stored on the computer is identified in connection with a same port as the first printer driver, and changing at least one setting of the second printer driver to match the changed setting of the first printer driver if the second printer driver is identified in connection with the same port as the first printer driver.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a network system consistent with the present invention.

FIG. 2 is a flow diagram of a printer driver updating process consistent with the present invention.

FIGS. 3A-3C are screen shots of exemplary user interfaces usable in the printer driver updating process of FIG. 2.

FIG. 4 is a flow diagram of a printer driver configuring process consistent with the present invention.

FIGS. 5A-5D are screen shots of exemplary user interfaces usable in the printer driver configuring process of FIG. 4.

### DETAILED DESCRIPTION OF PREFERRED EMBODIMENTS

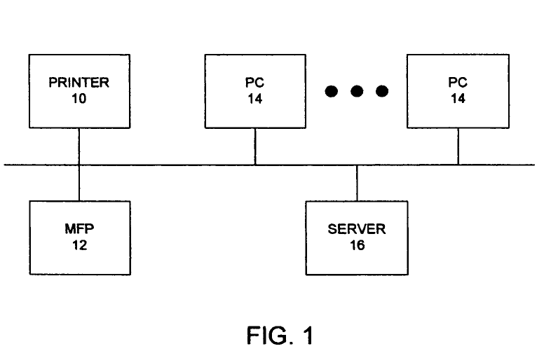

FIG. 1 is a block diagram of a network system consistent with the present invention. As shown in FIG. 1, the network includes a printer 10, an MFP 12, a plurality of PCs 14, and a server 16. The network may include other devices, such as scanners or faxes, and more than one of the devices shown, such as a plurality of printers 10 and/or MFPs 12, or any other devices capable of communicating with the network.

The printer 10 and MFP 12 are examples of hardcopy devices, which are capable of producing hardcopy reproductions of documents or images. The hardcopy devices (e.g., the printer 10 and the MFP 12) may be color and/or monochrome devices that are capable of generating color reproductions and/or monochrome reproductions of documents and images. Each hardcopy device includes an interface that is capable of receiving the data to be reproduced from one of the PCs 14, the server 16, or some other device that can be coupled to the hardcopy device via the interface. The interface can be a network interface, such as a LAN card, or can be a local connection, such as a printer port. Each hardcopy device preferably includes some type of storage, such as a hard disk drive, non-volatile memory and RAM. Data in the storage includes programming and instructions used to control the operation of the hardcopy device. The storage, such as for MFP 12, can also be used to store documents and images that may be reproduced by the hardcopy device.

The hardcopy devices can include several components for reproducing the received data. For example, the hardcopy devices can include an image processing unit that can perform one or more image processing algorithms on the received data, such as color conversion, gamma correction, filtering, dithering, halftone processing, color smoothing or other known processes. The data from the image processing unit is provided to an image reproduction unit. The image reproduction unit can generate a reproduction of the document or image on an image receiving element such as paper based on the data output from the image processing unit. The image reproduction unit may be, for example, a laser-type or inkjet type unit that generates the reproduction by use of a laser or inkjet, respectively. The paper on which the document or image is reproduced is received by a fusing unit which fuses the ink or toner to the paper. The fusing unit provides the fused paper to a finishing unit, which can collate, staple or hole punch the paper output from the fusing unit.

The PCs 14 can be implemented as any type of computing device. Typically, the PCs 14 include a processor or CPU, a hard disk drive, RAM, and some other form of non-volatile memory, such as NVRAM or an EPROM. The hard disk drive and the non-volatile memory are configured to store programs and instructions executed by the processor to control the operation of the PCs 14. In particular, when configured to operate with a hardcopy device, the hard disk drive and the non-volatile memory can store one or more printer drivers that ensure that the PCs 14 properly communicate with the hardcopy device and enable the PCs 14 to issue print jobs to the hardcopy device. In addition, this storage can also be used to store documents and images that may be reproduced on a hardcopy device.

The PCs 14 can also include one or more interfaces such as a network interface, a parallel port, and a serial port. The interfaces enable the PCs 14 to communicate with one or more devices, either through a network, such as a LAN or the Internet, or through a local connection using a parallel port or a serial port. The interfaces can also be implemented using any form of network connecting including wired, wireless, or satellite.

The server 16 can be designed and configured in a manner similar to the PCs 14. In addition to the elements of the PCs 14, the server 16 may include programming and instructions for performing additional functions beyond those of the PCs 14, such as administrative procedures and network administration. The server 16 can also serve as a gateway for connecting the PCs 14, the MFP 12 and the printer 10 to other devices on the Internet.

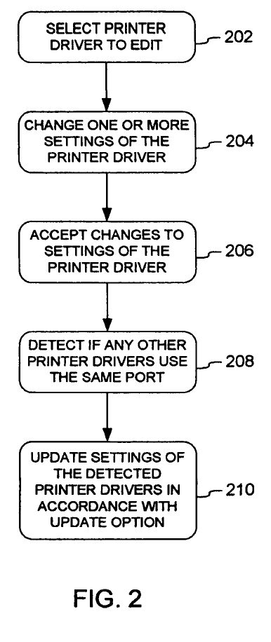

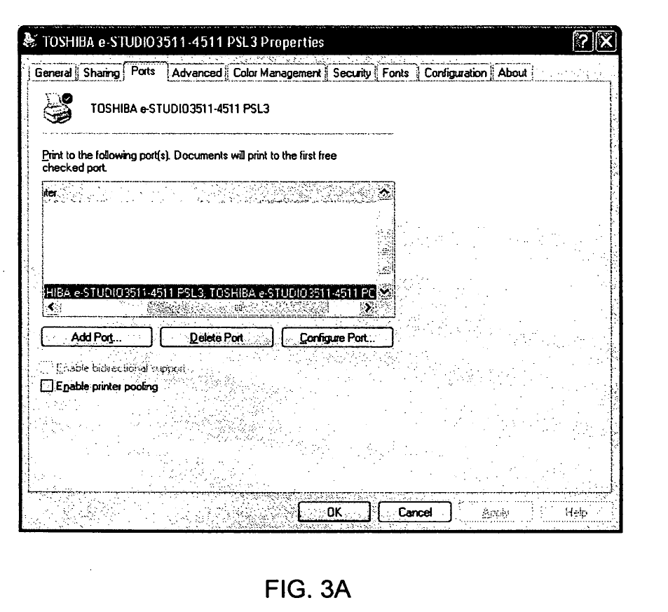

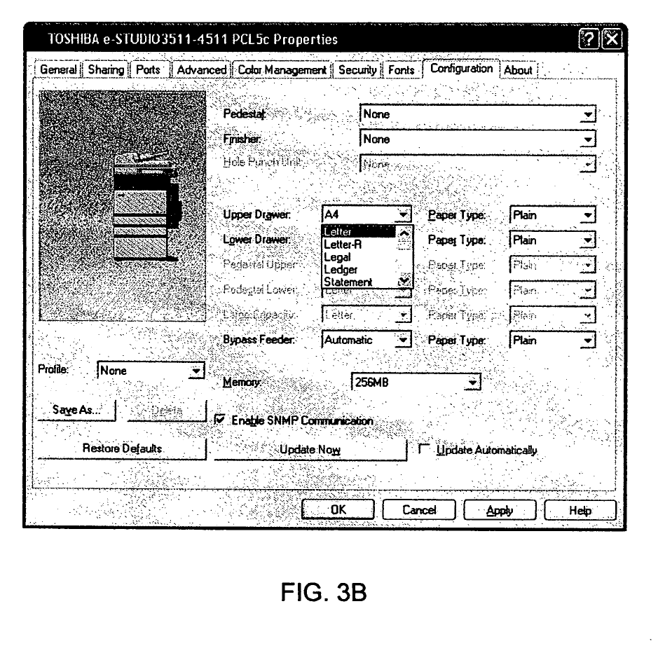

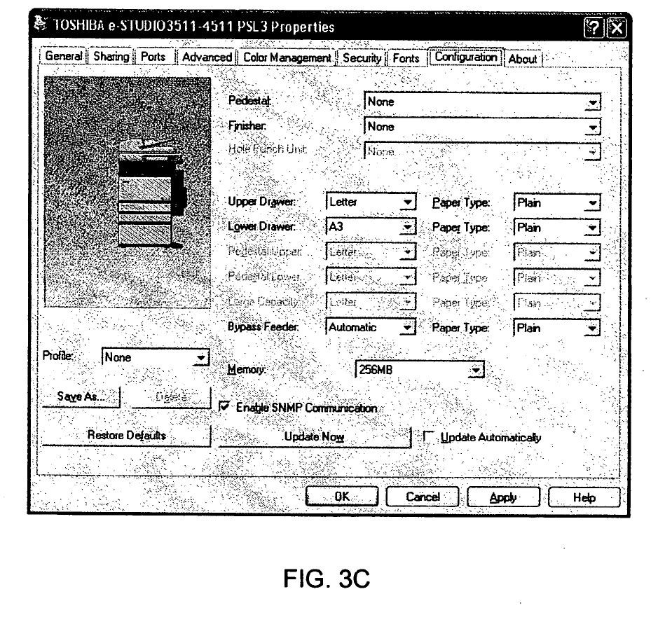

FIG. 2 is a flow diagram of an exemplary printer driver updating process consistent with the present invention. As described above, the PCs 14 and the server 16 can include one or more printer drivers to enable them to communicate properly with hardcopy devices, such as printer 10 and MFP 12. It is possible to change the configurations of the printer drivers based on a desired processing of print jobs or based on changes to the hardcopy device itself. In particular, as shown in FIG. 2, a user can select a printer driver to edit (step 202). To select a printer driver to edit, the user determines the location of the printer driver and selects the printer driver to edit with a keystroke or selection with a pointing device, such as a mouse or touchpad. The selection of a printer driver and editing of a printer driver settings or configuration is well known in the art and generally depends upon the operating system being used and the type of hardcopy device. FIG. 3A shows an example of a graphical user interface displaying printer drivers of a particular port.

After selecting a printer driver to edit, the user can select one or more settings to change (step 204). FIG. 3B shows an example of a user interface showing the settings of a printer driver than can be changed or reconfigured. As shown in FIG. 3B, the settings include the pedestal, the finisher, the paper size for various drawers, the paper type for those drawers, the bypass feeder, the paper type for the bypass feeder, the profile, and the memory size. In addition, the settings allow for an “Update Automatically” option, which will be described in greater detail below. Other settings, not shown in FIG. 3B, may also be included for the printer driver. The particular settings available are generally based on the type of hardcopy device. To change a setting, the user can select from a drop down menu showing the different options available, or the user can manually enter in the particular desired setting. Any type of settings that can be changed is contemplated to fall with the scope of this embodiment.

When the user has finished changing the settings for the printer driver, the user inputs an indication of the acceptance of those changes (step 206). To accept the changes, the user can select an appropriate button in the user interface, such as “Apply” or “OK.” Both of these options are shown, for example, in the user interface of FIG. 3B.

In addition to accepting the changes to the particular printer driver being edited, the system detects if any other printer drivers are assigned to the same port as the edited printer driver (step 208). To perform this detection, the PC 14 or server 16 includes programming or instructions that instruct the computing device to search for the presence of other printer drivers using the same port. The programming or instructions may be implemented, for example, as part of a plug-in application or driver, or alternatively can be implemented as part of the operating system. It is also possible for the programming or instructions to be implemented as part of the printer driver, so that the edited printer is configured to detect if another printer driver is using the same port. The search for the presence of other printer drivers using the same port may be effected by an examination of the registry information, or its equivalent depending on the operating system being employed, which typically stores information identifying the port that each printer driver uses.

If another printer driver is using the same port as the edited printer driver, then the detected printer driver is updated to match the changed settings of the edited printer driver in accordance with the update option (step 210). The updating can be effected using the same plug-in application, driver or operating system used to detect if a printer driver is using the same port. Alternatively, the updating can be done by configuring the edited printer driver and/or the detected printer driver to communicate the changes made and update the detected printer driver to match the changed settings. The update option determines whether the update of the detected printer driver is done automatically without user approval or if the user makes an affirmative input to have the update performed. For example, with reference to FIG. 3B, if the “Update Automatically” option is set, than the detected printer driver is updated automatically. Alternatively, if the “Update Automatically” option is not available for the printer driver, the default setting of the driver or plug-in application can be to update the detected printer driver automatically without prompting the user, or alternatively presenting the user with an option and requesting user approval for the update.

As also shown in FIG. 3B, the user interface includes an “Update Now” button. To initiate the update of other printer drivers using the same port as the edited printer driver, the user can select this button, and the other printer drivers are updated automatically to match the changes made to the edited printer driver. Alternatively, after accepting the changes to the edited printer driver, a window or interface can be generated that prompts the user to indicate whether or not to update the other printer drivers that are using the same port as the edited printer driver.

FIG. 3C provides an example of a user interface illustrating the updating of settings for a printer driver to match the changed settings of an edited printer driver sharing the same port. In FIG. 3B, a user had changed the paper size in the upper drawer from A4 to Letter size. This change was specifically made for printer driver PCL 5c. As shown in FIG. 3C, printer driver PSL 3, which shares the same port as the printer driver PCL 5c, has been updated (according to the process outlined above) to reflect the change made to the setting of the printer driver PCL 5c, i.e., the paper size in the upper drawer has been changed from A4 to Letter size. Further, if more than one other printer driver uses the same port as the edited printer driver, then each of those printer drivers is updated to reflect the changes made to the edited printer driver.

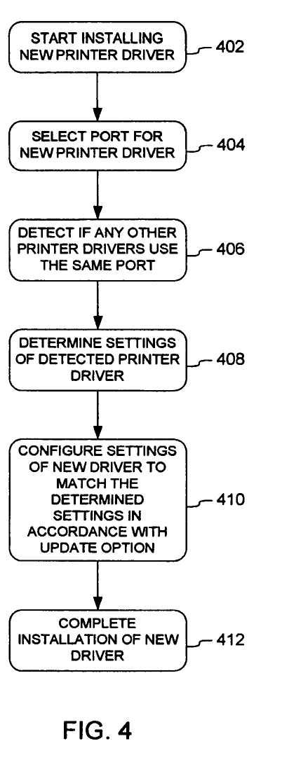

In the update process of FIG. 2, an existing printer driver is edited and changes are made to one or more settings of the edited printer driver. The change or changes made to the edited printer driver are also applied to any other printer driver that uses the same port as the edited printer driver. A printer driver update process can also be applied to the installation and configuration of a new printer driver. FIG. 4 is a flow diagram of a printer driver configuring process consistent with the present invention. As shown in FIG. 4, a user can initiate the installation of a new printer driver for a hardcopy device, such as printer 10 or MFP 12 (step 402). The new printer driver can be installed, for example, from a CD-ROM loaded into a PC 14 or the server 16. Alternatively, the printer driver can be downloaded from a web site, such as from the site of the manufacturer of the hardcopy device.

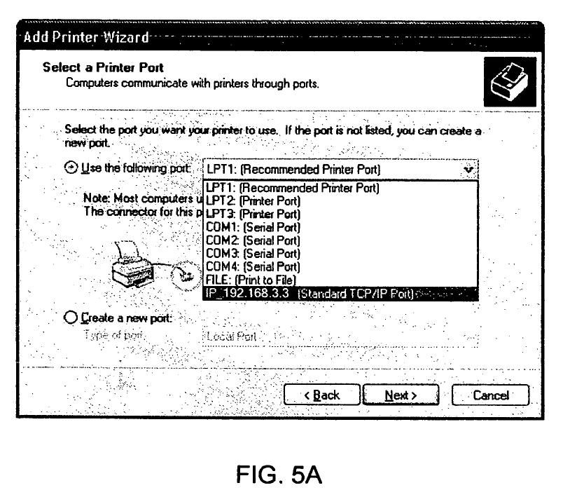

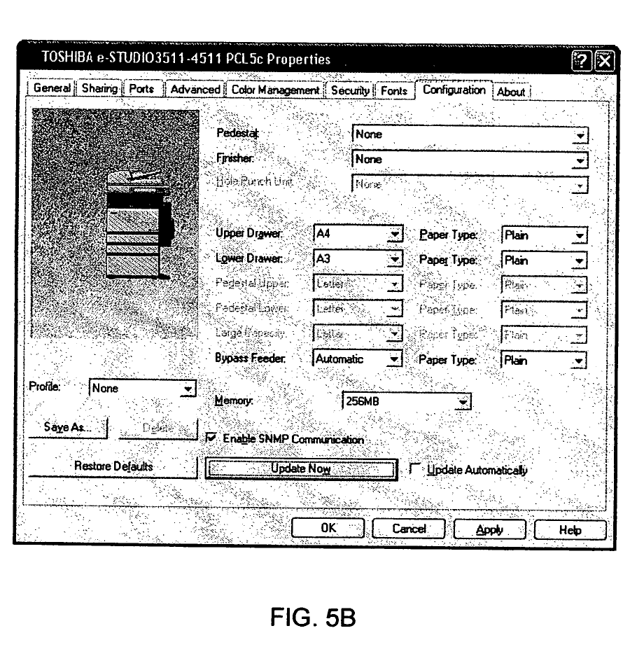

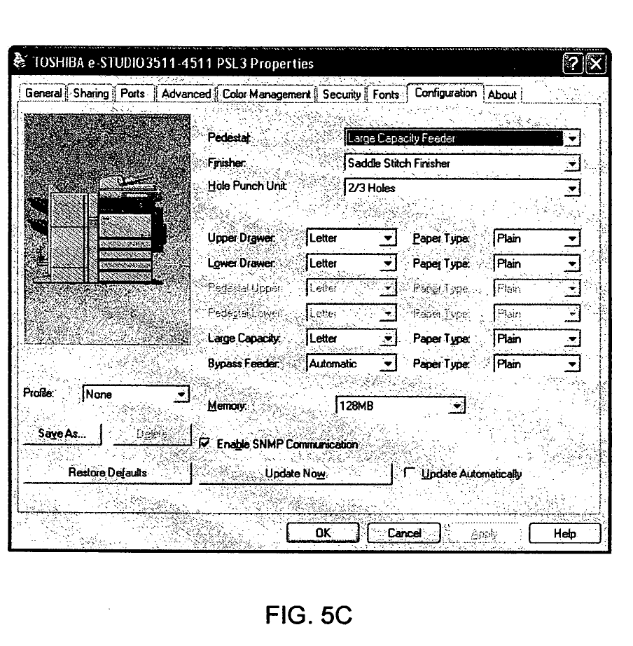

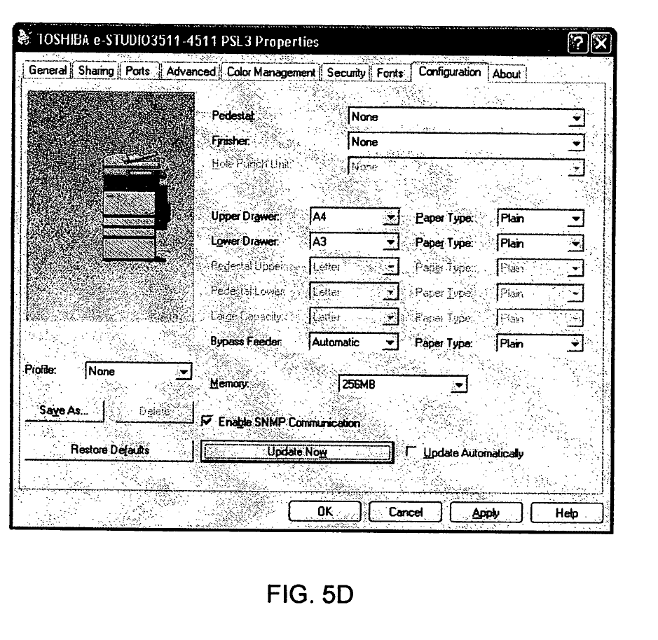

During the installation of the new printer driver, the user can identify the port for the hardcopy device to which the new printer driver is associated (step 404). The port selected by the user can be an existing port, or the user can create a new port. FIG. 5A shows an example of a user interface during the installation process in which a user is prompted to select a port to be used by the hardcopy device. As shown in FIG. 5A, a user can select an existing port to use from a drop down menu listing the available ports or can select to create a new port. In the particular example of FIG. 5A, the user installing a new printer driver PSL3 has selected the port IP_{—}192.168.3.3.

In accordance with the port selected by the user, it is detected whether any other printer driver is using the same port (step 406). As in the process of FIG. 2, to perform this detection, the PC 14 or server 16 can include programming or instructions that instruct the computing device to search for the presence of other printer drivers using the same port. Also, the programming or instructions may be implemented as part of a plug-in application or driver, or alternatively can be implemented as part of the operating system. The search for the presence of other printer drivers using the same port may be effected by an examination of the registry information, or its equivalent.

If the detection process indicates that a printer driver is detected that is using the same port as the new printer driver, then the settings or configuration of the detected printer driver are determined (step 408). The settings or configuration of the detected printer driver may include, for example, the type of feeder, the type of finisher, use of a hole punch, paper size for each drawer, paper type, profile, memory size, and any other setting that may be used to configure a printer driver. To determine the settings for the detected printer driver, the PC 14 or server 16 can include programming or instructions that instruct the computing device to determine the settings or configuration for the detected printer driver. The programming or instructions may be implemented as part of the same plug-in application, driver or operating system used to detect the printer driver using the same port.

FIG. 5B shows an example of a user interface displaying the settings or configuration for a printer driver detected as using the same port as the new printer driver. In the example shown in FIG. 5B, the printer driver PCL 5c has various settings including, for example, the paper size and type for upper and lower drawers and the memory size.

Having determined the settings for the detected printer driver using the same port, the settings of the new printer driver are configured to match these determined settings in accordance with the update option (step 410). The performance of configuring the settings for the new printer driver can be effected using the same plug-in application, driver or operating system used to detect if a printer driver is using the same port and to determine the settings of the detected printer driver. The update option is analogous to that described above in the process of FIG. 2.

FIG. 5C shows an example of a user interface displaying the default configuration for the new printer driver, and FIG. 5D shows an example of a user interface configured to match the settings of an existing printer driver using the same port. As shown in FIG. 5C, the new printer driver PSL3 has settings for the pedestal, finisher, and hole punch unit, as well as settings for the paper size and type for the upper and lower drawers, the large capacity feeder, and the bypass feeder.

In the absence of the functions of detecting a printer driver using the same port, determining the detected printer drivers settings, and configuring the settings of the new printer driver to match the determined settings, a user would be forced to manually change the settings of the new printer driver to match the settings of the detected printer driver. In accordance with the process of FIG. 4, however, the settings of the new printer driver are configured to match the determined settings of the detected printer driver without requiring the user to manually configure each setting. This matching of the settings is shown in FIG. 5D. As shown in FIG. 5D, the settings of the new printer driver PSL3 are configured to match the determined settings of the existing printer driver PCL 5c, as shown in FIG. 5B. For example, the paper size of the upper drawer for the new printer driver is set to A4 instead of the default setting of letter (the default being shown in FIG. 5C).

With the settings of the new printer driver configured to match the settings of the existing printer driver using the same port, the installation of the new printer driver can be completed (step 412). Once the installation of the new printer driver is complete, both the new printer driver and the existing printer driver using the same port can be used to provide print jobs to the hardcopy device in accordance with the settings of the print job.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for configuring printer driver settings of printer drivers stored on a computer, the printer drivers enabling communication between the computer and a hardcopy device capable of printing, the method comprising:
changing a setting of a first printer driver stored on the computer in response to a user request;
detecting whether a second printer driver stored on the computer is identified in connection with a same port as the first printer driver; and
changing at least one setting of the second printer driver to match the changed setting of the first printer driver if the second printer driver is identified in connection with the same port as the first printer driver.

2. A method according to claim 1, wherein the step of changing the at least one setting of the second printer driver is carried out automatically, without a user request to change the at least one setting of the second printer driver.

3. A method according to claim 1, wherein the first printer driver is one of a postscript printer driver and a printer control language printer driver, and the second printer driver is the other of a postscript printer driver and a printer control language printer driver.

4. A method according to claim 1, further comprising:
detecting whether a third printer driver stored on the computer is identified in connection with a same port as the first printer driver;
changing at least one setting of the third printer driver to match the changed setting of the first printer driver if the third printer driver is identified in connection with the same port as the first printer driver.

5. A method according to claim 4, wherein the step of changing the at least one setting of the third printer driver is carried out automatically, without a user request to change the at least one setting of the third printer driver.

6. A method according to claim 1, wherein the at least one setting that may be changed includes at least one of a finisher setting, a paper type, or a paper size.

7. A method according claim 1, wherein the detecting step includes referencing a registry stored on the computer to determine whether the second printer driver is identified in connection with the same port as the first printer driver.

8. A method according to claim 1, wherein the step of changing the at least one setting of the first printer driver includes changing a plurality of settings of the first printer driver, and
wherein the step of changing the setting of the second printer driver includes changing a plurality of settings of the second printer driver to match the plurality of settings changed for the first printer driver.

9. A method according to claim 1, further comprising:
receiving a user request to update settings of the second printer driver,
wherein, in response to receiving the user update request, the setting of the second printer driver is changed to match the at least one setting changed for the first printer driver.

10. A method according to claim 1, further comprising:
receiving an acceptance of the change to the setting of the first printer driver; and
determining whether an automatic update option has been set,
wherein, if the automatic update option has been set, changing the setting of the second printer driver to match the at least one setting changed for the first printer driver in response to the received acceptance of the change to the setting of the first printer driver.

11. A method according to claim 1, further comprising:
receiving an acceptance of the change to the setting of the first printer driver; and
wherein the setting of the second printer driver is changed to match the at least one setting changed for the first printer driver in response to the received acceptance of the change to the setting of the first printer driver.

12. A method for configuring printer driver settings of printer drivers stored on a computer, the printer drivers enabling communication between the computer and a hardcopy device capable of printing, the method comprising:
installing a first printer driver on the computer;
determining whether the first printer driver is being assigned to a same port as a second printer driver that is installed on the computer;
detecting at least one setting for the second printer driver; and
configuring a setting of the first printer driver to match the detected at least one setting for the second printer driver.

13. A method according to claim 12, wherein the step of configuring a setting of the first printer driver is carried out automatically without a user request to match the detected at least one setting of the second printer driver.

14. A method according to claim 12, wherein the first printer driver is one of a postscript printer driver and a printer control language printer driver, and the second printer driver is the other of a postscript printer driver and a printer control language printer driver.

15. A method according to claim 12, wherein the at least one setting that may be detected includes at least one of a finisher setting, a paper type, and a paper size.

16. A method according claim 12, wherein the determining step includes referencing a registry stored on the computer to determine whether the first printer driver is identified in connection with the same port as the second printer driver.

17. A method according to claim 12, wherein the step of detecting at least one setting of the second printer driver includes detecting a plurality of settings of the second printer driver, and
wherein the step of configuring the first printer driver further includes configuring a plurality of settings of the first printer driver to match the detected plurality of settings of the second printer driver.

18. A method according to claim 12, further comprising:
receiving a user request to configure the first printer driver to match the at least one setting of the second printer driver,
wherein, in response to receiving the user update request, the setting of the first printer driver is configured to match the detected at least one setting of the second printer driver.

19. A method according to claim 12, further comprising:
determining whether an automatic update option has been set,
wherein, if the automatic update option has been set, configuring the first printer driver to match the detected at least one setting of the second printer driver in response to the detecting of the at least one setting of the second printer driver.

20. A computer readable medium operable on a computer for configuring printer driver settings of printer drivers stored on the computer, the printer drivers enabling communication between the computer and a hardcopy device capable of printing, the computer readable medium configured to:
change a setting of a first printer driver stored on the computer in response to a user request;
detect whether a second printer driver stored on the computer is identified in connection with a same port as the first printer driver; and
change at least one setting of the second printer driver to match the changed setting of the first printer driver if the second printer driver is identified in connection with the same port as the first printer driver.

21. A computer readable medium operable on a computer for configuring printer driver settings of printer drivers stored on the computer, the printer drivers enabling communication between the computer and a hardcopy device capable of printing, the computer readable medium configured to:
install a first printer driver on the computer;
determine whether the first printer driver is being assigned to a same port as a second printer driver that is installed on the computer;
detect at least one setting for the second printer driver; and
configure a setting of the first printer driver to match the detected at least one setting for the second printer driver.
